(19) United States
(12) Patent Application Publication
(10) Pub. No.: US 2007/0171278 A1
(43) Pub. Date: Jul. 26, 2007

(54) Multimedia greeting card

(76) Inventor: Tony Chen, Irvine, CA (US)

Correspondence Address: LIN & ASSOCIATES INTELLECTUAL PROPERTY, P.O. BOX 2339, SARATOGA, CA, 95070-0339, US

(21) Appl. No.: 11/338,520

(22) Filed: Jan. 23, 2006

(51) Int. Cl. H04N 7/18; H04N 9/47

(52) U.S. Cl. 348/61

(57) ABSTRACT

A multimedia greeting card comprises a speaker, a memory unit, a power supply, a controller, a button, a rectangular frame and a paperboard having multiple folding pages and wrapping around the frame. The frame has multiple holders for holding the speaker, the button, and a circuit board on which the memory unit, the power supply and the controller are installed. An outer folding page of the paperboard has one set of speaker openings and a button opening faced to the speaker and the button, respectively. An adhesive can be alternatively used to obtain secure attachment of the paperboard with the frame. The multimedia greeting card further comprises an LCD device held on a holder of the frame, and the paperboard has a LCD window faced to the LCD device. When pressing the button, it playbacks multimedia files stored in the memory unit through the speaker and the LCD device.

### BACKGROUND OF THE INVENTION

1. Field of the Invention

The present invention relates to a greeting card, and in particular to a multimedia greeting card that allows addressees to play a pre-recorded multimedia file by pressing a button.

2. The Prior Arts

Paper greeting cards have been widely used in some occasions, such as graduations, birthday parties, weddings, opening ceremonies, company introduction and other commercial or industrial purposes. Traditional text information generally found on paper greeting cards has been enhanced in electronic greeting cards with multimedia effect.

When holding inaugurations, opening ceremonies or anniversary celebrations, organizers may send invitation cards to invite guests to come to celebration sites, their special features and products will be introduced to attract more participation in the event.

In order to augment the celebration effect, electronic greeting card producers have incorporated a miniature electronic device and a speaker in the electronic greeting cards. When card addressees open up the card, the electronic device begins to playback pre-recorded message to them, such as “we represent . . . and we would like to invite you to the event . . . ” But this new feature is sometimes bothering the addressees who may be only interested in the text information printed on the inside page, or just want to look at the pictures printed thereon without distraction.

Recently, another kind of digital greeting card, which is called E-card and is sent through Email, has been introduced. Although this kind of card can provide a multimedia effect and strengthen its propaganda and specialization, it shall be received and browsed through computers or PDAs, thereby limiting its applications. Besides, the cost for PDAs or similar electronic devices is not economically justifiable for the purpose of creating a multimedia card.

### SUMMARY OF THE INVENTION

A primary object of the present invention is to provide a multimedia greeting card that employs a button to control playback of pre-recorded multimedia files, thereby allowing addressees to decide whether or not to play the files when looking through the content of the card.

A secondary object of the present invention is to provide a multimedia greeting card having an LCD device and a speaker constructed therein to enhance the multimedia effect.

A tertiary object of the present invention is to provide a multimedia greeting card that is made with simpler design and at far lower cost than conventional PDAs or similar electronic greeting cards.

A further object of the present invention is to provide a multimedia greeting card that allows colorful pictures to be printed on outer surfaces thereof.

To achieve the above-mentioned objects, a multimedia greeting card in accordance with the present invention comprises a speaker, a memory unit, a power supply, a controller, a button, a rectangular frame and a paperboard having multiple folding pages and wrapping around the frame. The frame has multiple holders for holding the speaker, the button, and a circuit board on which the memory unit, the power supply and the controller are installed. An outer folding page of the paperboard has one set of speaker openings and a button opening faced to the speaker and the button, respectively. An adhesive can be alternatively used to obtain secure attachment of the paperboard with the frame. The multimedia greeting card further comprises an LCD device held on a holder of the frame, and the paperboard has a LCD window faced to the LCD device. When pressing the button, it playbacks multimedia files stored in the memory unit through the speaker and the LCD device.

The present invention will become more obvious from the following description when taken in connection with the accompanying drawings, which show, for purposes of illustration only, preferred embodiments in accordance with the present invention. In the drawings:

### BRIEF DESCRIPTION OF THE DRAWINGS

FIG. 1 is a schematic view of a frame of a multimedia greeting card in accordance with a first preferred embodiment of the present invention;

FIG. 2 is a schematic view showing that a speaker, a button, and a circuit board on which a memory unit, a battery set and a controller are installed, are mounted on the frame in FIG. 1;

FIG. 3 is a schematic view of a paperboard of the multimedia greeting card in accordance with the first preferred embodiment of the present invention;

FIG. 4 is a schematic view of the multimedia greeting card in accordance with the first preferred embodiment of the present invention, wherein the paperboard in FIG. 3 wraps around the frame in FIG. 2;

FIG. 5 is a schematic view of a frame of a multimedia greeting card in accordance with a second preferred embodiment of the present invention;

FIG. 6 is a schematic view of the multimedia greeting card in accordance with the second preferred embodiment of the present invention, wherein a paperboard wraps around the frame in FIG. 5;

FIG. 7 is a schematic view of a group button in accordance with the present invention; and

FIG. 8 is a schematic view of a multiple menu in accordance with the present invention.

### DETAILED DESCRIPTION OF THE PREFERRED EMBODIMENT

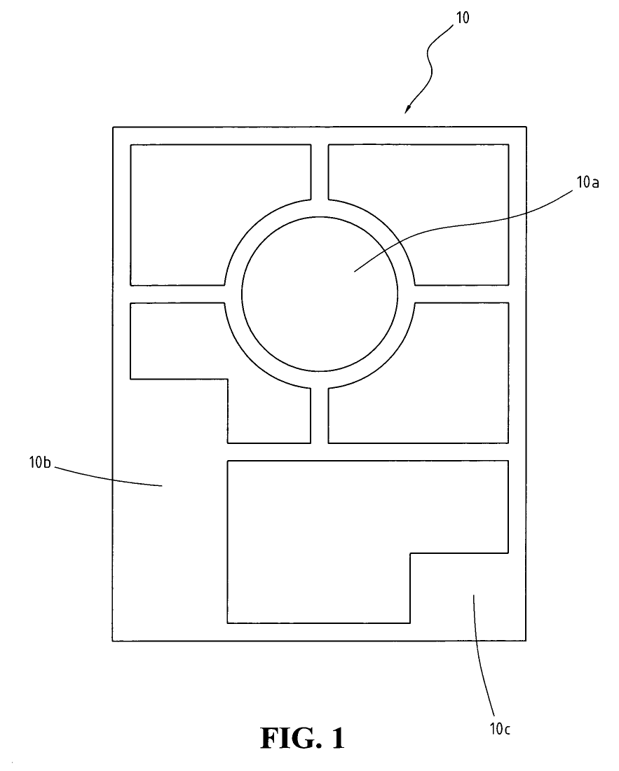

Referring to FIGS. 1-4, a multimedia greeting card 1 in accordance with the present invention comprises a rectangular hollow frame 10 and a paperboard 30 having multiple folding pages and wrapping around the frame 10.

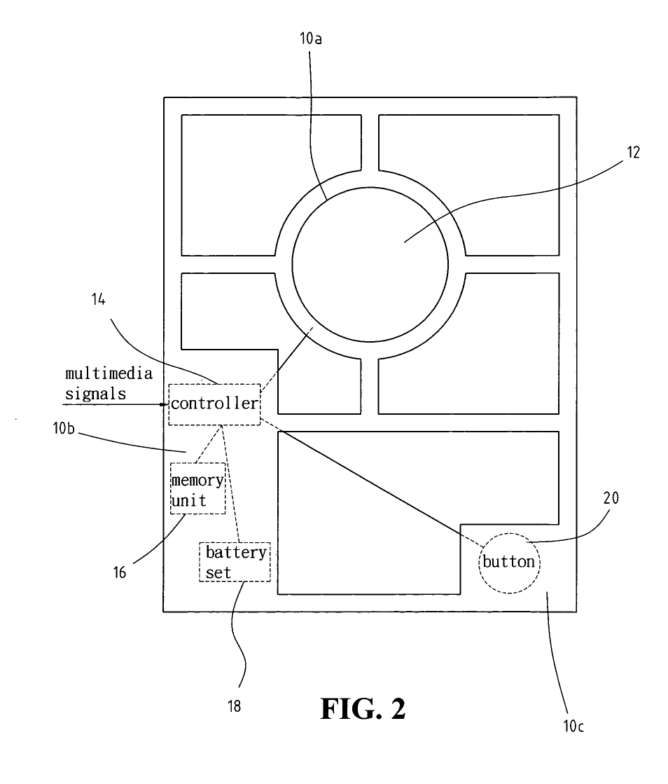

Also referring to FIGS. 1 and 2, the rectangular frame 10 has three holders 10a, 10b and 10c at predetermined positions, where the round shaped holder 10a is for holding a speaker 12, the rectangular shaped holder 10b is for holding a circuit board on which a memory unit 16, a controller 14 and a power supply, such as battery set 18, are installed, and the square shaped holder 10c is for installing a button 20. It shall be noted that the holders 10a, 10b and 10c are not limited to the above-mentioned shapes. The holders 10a, 10b and 10c may be of any shapes so long as they can satisfy the requirements of fixation. The battery set 18 includes solar battery or any other kind of batteries.

The battery set 18 is electrically connected to the speaker 12, the memory unit 16 and the controller 14, and the controller 14 is electrically connected to the button 20, so as to enable addressees to randomly play multimedia files recorded in the memory unit 16 by pressing the button 20.

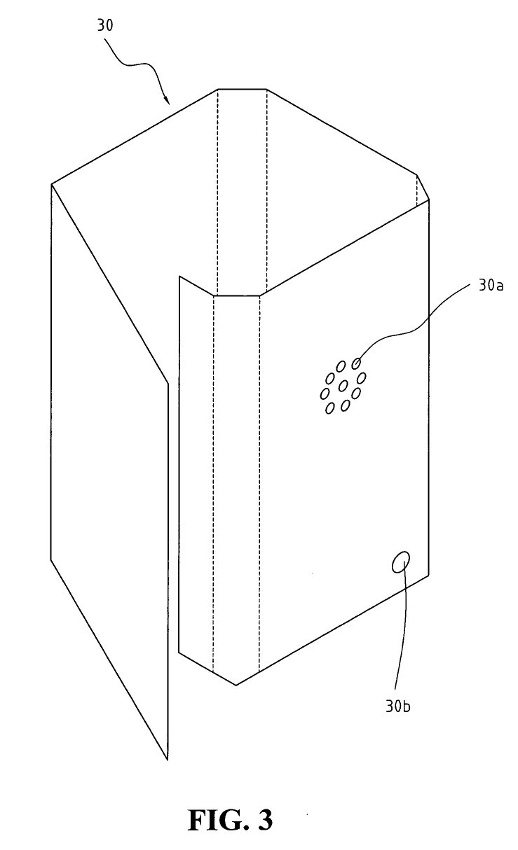

Referring to FIG. 3, the paperboard 30 has one set of speaker openings 30a and a button opening 30b on an outer folding page, where the speaker openings 30a and the button opening 30b are arranged to be faced to the speaker 12 and the button 20 installed on the frame 10, respectively. The speaker openings 30a is to allow for sound transmission to the outside, and the button opening 30b is to facilitate hand access to the button 20.

The outside surfaces of the paperboard 30 may be printed with pictures or colorful printings that can enhance its delicate effect. The paperboard 30 can be further laminated with a transparent protection film, cotton or silk materials to enhance its exquisite texture.

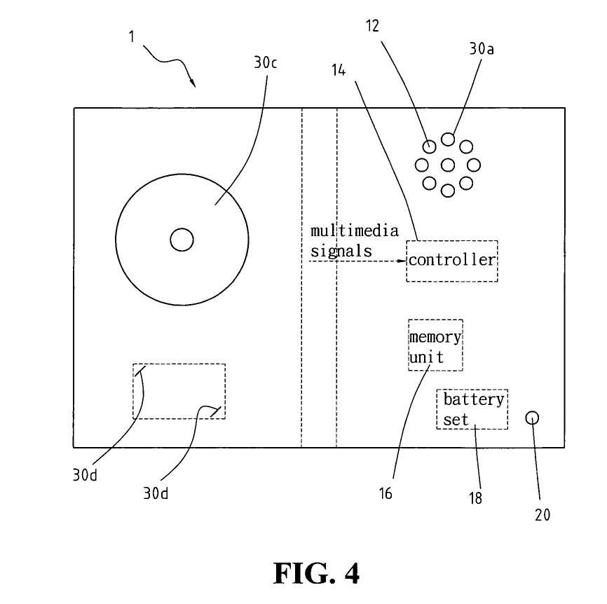

Referring to FIG. 4, the multiple folding pages of the paperboard 30 are folded and wrapped around the frame 10 on which the speaker 12, the button 20 and the circuit board with the memory unit 16, the battery set 18 and the controller 14 installed thereon are mounted. In order to make sure attachment of the frame 10 with the paperboard 30, an adhesive can be used to obtain their secure attachment with each other.

Also referring to FIG. 4, the paperboard 30 further has a CD holder 30c for holding a CD on an upper portion of another folding page of the paperboard 30, and a pair of slant cuts 30d for holding a business card located below the CD holder 30c.

After receiving the multimedia greeting card in accordance with the present invention, addressees may open up the card to read the text messages prepared by the card sender and may also press down the button 20 to play the multimedia files pre-recorded on the memory unit 16. When the button 20 is pressed down, an enable signal is sent to the controller 14, which then reads the multimedia files from the memory unit 16 and transmits audio signals to the speaker 12 for audio playback. Furthermore, the controller 14 can receive multimedia signals through an AV terminal and transform them to multimedia files and then store them in the memory unit 16. Therefore, the card sender can pre-load messages and addressees' favorite music in the memory unit 16.

Unlike conventional electronic greeting cards, which automatically play multimedia files as they are opened, the multimedia greeting card according to the present invention plays the multimedia files only when the button 20 is pressed down, thereby being able to reduce disturbances to addressees.

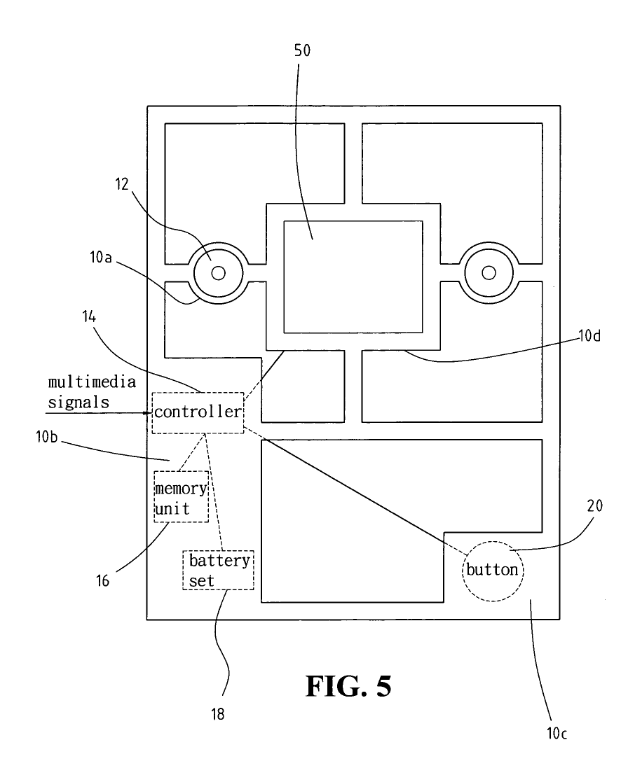

Referring to FIG. 5, a frame 10 in accordance with a second preferred embodiment of the present invention comprises a holder 10a for holding two speakers 12, a holder 10b for holding a circuit board having a memory unit 16, a controller 14 and a battery set 18 installed thereon, a holder 10c for installing a button 20, and a holder 10d for holding an LCD device 50.

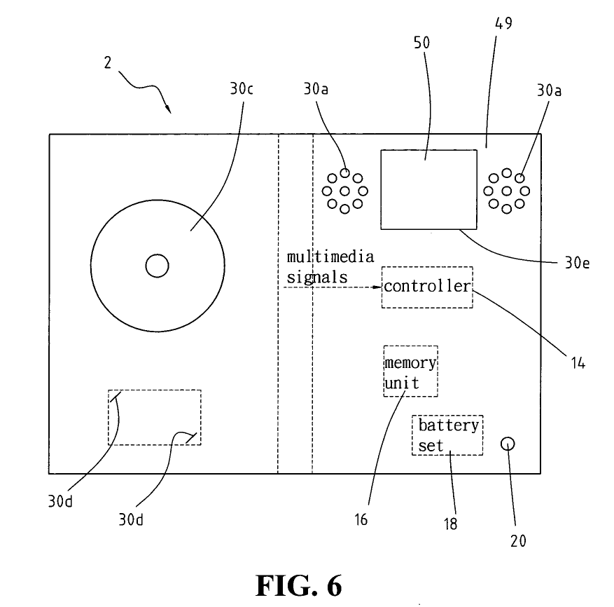

Referring to FIG. 6, which shows a multimedia greeting card 2 in accordance with the second preferred embodiment of the present invention, multiple folding pages of a paperboard 49 are folded and wrapped around the frame 10. The paperboard 49 has two sets of speaker openings 30a, a button opening 30b and an LCD window 30e on an outer folding page, wherein the speaker openings 30a, the button opening 30b and the LCD window 30e are arranged to be faced to the two speakers 12, the button 20 and the LCD device 50 installed on the frame 10, respectively. Further, the paperboard 49 also has a CD holder 30c for holding a CD on an upper portion of another folding page of the paperboard 49, and a pair of slant cuts 30d for holding a business card located below the CD holder 30c. In order to make sure attachment of the frame 10 with the paperboard 49, an adhesive can be used to obtain their secure attachment with each other.

As illustrated above, after receiving the multimedia greeting card in accordance with the second preferred embodiment of the present invention, addressees may open up the card to read the text messages prepared by the card sender and may also press down the button 20 to play the multimedia files pre-recorded on the memory unit 16 though the speaker 12 and the LCD device 50. Furthermore, the controller 14 can receive multimedia signals through an AV terminal and transform them to multimedia files and then store them in the memory unit 16. Therefore, the card sender can pre-load messages and addressees' favorite music in the memory unit 16. It should be noted that the memory unit 16 might be instead of flash memory, such as SD card and CF card, which can be read by card reader, thereby the multimedia files being able to be directly played from SD cards.

In such a manner, the multimedia greeting card according to the second preferred embodiment of the present invention supports multimedia functions in the same way as a PDA or an equivalent electronic device, but the multimedia greeting card is made with simple design and can be produced at a far lower cost than a PDA. Besides, the multimedia greeting card can be printed with delicate patterns, thereby enhancing its attraction.

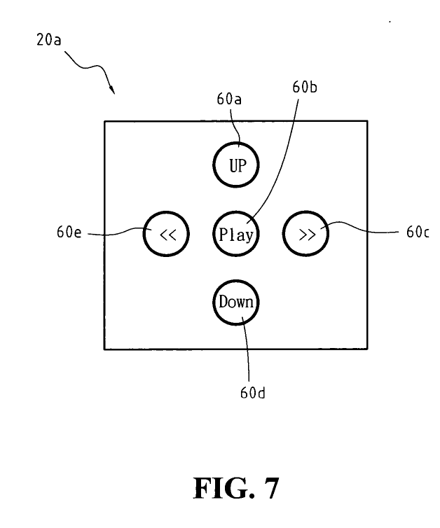

If the multimedia files are constructed to a multiple menu, the button 20 shall be changed to a group button. Referring to FIG. 7, a group button 20a in accordance with the present invention comprises an up button 60a, a down button 60d, a play button 60b, a right button (or a fast forward button) 60c, and a left button (or a fast reverse button) 60e. The group button 20a can further comprise other control buttons according to desires.

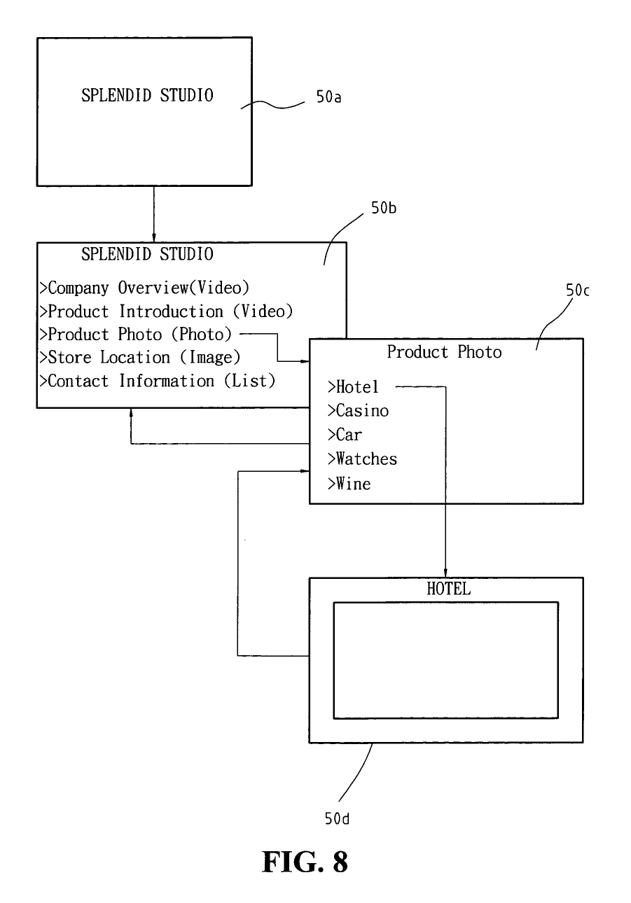

Referring to FIG. 8, a multiple menu in accordance with the present invention comprises at least menus 50a, 50b, 50c and 50d. When addressees push down the play button 60b in FIG. 7, the controller 14 accesses a multiple menu from the memory unit 16 and then displays the menus 50a and 50b on the LCD device 50 to wait for addressees' operational selection. When the addressee pushes the down button 60d to choose “Product Photo (Photo)”, the menu 50c is displayed on the LCD device 50 under the control of the controller 14. If the addressee further chooses “Hotel”, the menu 50c is displayed. Other operations aren't mentioned repeatedly because they are the same as the prior art.

Compared with the conventional greeting cards, the multimedia greeting card in accordance with the present invention can further play multimedia files, such as audio/video files, in addition to the text information printed thereon when it is applied to graduations, birthday parties, weddings, opening ceremonies, company introduction and other commercial or industrial purposes. Addressees are given a choice whether or not to play the multimedia files with the button. Since the multimedia greeting card is made with simple design, so its manufacturing cost shall be considerably lower than a PDA or similar electronic device adapted for such purposes.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A multimedia greeting card, comprising:
a speaker;
a memory unit for storing multimedia files;
a power supply for supplying power;
a controller for controlling audio playback of the multimedia files through the speaker;
a button for activating the audio playback;
a rectangular frame having multiple holders for holding the speaker, the button, and a circuit board on which the memory unit, the controller and the power supply are installed, respectively; and
a paperboard having multiple folding pages and wrapping around the frame, wherein an outer folding page of the paperboard has one set of speaker openings faced to the speaker; and an adhesive can be alternatively used to obtain secure attachment of the paperboard with the frame.

2. The multimedia greeting card as claimed in claim 1, wherein outside surfaces of the paperboard are printed with colorful pictures.

3. The multimedia greeting card as claimed in claim 1, wherein the paperboard has a pair of slant cuts on another folding page for holding a business card.

4. The multimedia greeting card as claimed in claim 1, wherein the paperboard has a CD holder on said another folding page for holding a CD.

5. The multimedia greeting card as claimed in claim 1, wherein the outer folding page of the paperboard has a button opening faced to the button.

6. The multimedia greeting card as claimed in claim 1, further comprising an AV terminal for receiving multimedia files from an outside device under the control of the controller, which are then stored in the memory unit.

7. A multimedia greeting card, comprising:
at least one speaker;
an LCD device;
a memory unit for storing multimedia files;
a power supply for supplying power;
a controller for controlling audio/video playback of the multimedia files through the speakers and the LCD device;
a button for activating the audio/video playback;
a rectangular frame having multiple holders for holding the speakers, the LCD device, the button, and a circuit board on which the memory unit, the controller and the power supply are installed, respectively; and
a paperboard having multiple folding pages and wrapping around the frame, wherein an outer folding page of the paperboard has at least one set of speaker openings and an LCD window faced to the speakers and the LCD device, respectively; and an adhesive can be alternatively used to obtain secure attachment of the paperboard with the frame.

8. The multimedia greeting card as claimed in claim 7, wherein outside surfaces of the paperboard are printed with colorful pictures.

9. The multimedia greeting card as claimed in claim 7, wherein the paperboard has a pair of slant cuts on another folding page for holding a business card.

10. The multimedia greeting card as claimed in claim 7, wherein the paperboard has a CD holder on said another folding page for holding a CD.

11. The multimedia greeting card as claimed in claim 7, wherein the outer folding page of the paperboard has a button opening faced to the button.

12. The multimedia greeting card as claimed in claim 7, further comprising an AV terminal for receiving multimedia files from an outside device under the control of the controller, which are then stored in the memory unit.
